(19) United States
(12) Patent Application Publication
(10) Pub. No.: US 2018/0010302 A1
(43) Pub. Date: Jan. 11, 2018

(54) APPARATUS AND METHOD FOR TAMPING BALLAST

(71) Applicant: HARSCO TECHNOLOGIES LLC, Fairmont, MN (US)

(72) Inventors: Damiano Padovani, Lafayette, IN (US); Monika Ivantysynova, Lafayette, IN (US)

(21) Appl. No.: 15/202,042

(22) Filed: Jul. 5, 2016

(51) Int. Cl. E01B 27/02; F04B 51/00; E01B 27/20; F15B 11/08

(52) U.S. Cl. CPC E01B 27/028; F15B 11/08; F04B 51/00; E01B 27/20; F15B 2211/20546; F15B 2211/7051

(57) ABSTRACT

The present disclosure generally relates to a railroad track ballast tamping vehicle and associated methods of use, wherein the vehicle comprises: a rigid frame; a variable-displacement servo-pump operatively coupled to the vehicle; at least one linear hydraulic actuator operatively coupled to the frame at a proximal end of the at least one linear hydraulic actuator and comprising: at least one internal cavity for receiving hydraulic fluid from the variable-displacement servo-pump via a hydraulic hose; and an actuator rod passing through a first internal cavity and a second internal cavity of the at least one linear hydraulic actuator; and a tamping tool operatively coupled to a distal end of the at least one linear hydraulic actuator. A tamping pad associated with the tamping tool may be lowered into ballast underlying railroad tracks and between railroad track ties for performing ballast tamping operations.

### TECHNICAL FIELD

Embodiments disclosed herein related to an apparatus and method for tamping ballast.

### BACKGROUND

Railroads are generally constructed of a pair of elongated, substantially parallel rails, which are coupled to a plurality of laterally extending ties via metal tie plates and spikes and/or spring clip fasteners. The rails and ties are disposed on a ballast bed formed of hard particulate material, such as gravel.

During installation of new railroad and maintenance of existing railroad, the ballast adjacent to and/or under the ties is “tamped,” or compressed, to ensure that the ties, and therefore the rails, do not shift. This tamping process ensures that the rails and ties are sufficiently aligned, stable, and/or durable.

A rail vehicle for carrying out tamping operations is generally referred to as a “tamper” and includes work heads for carrying out tamping operations. Such work heads typically include a workhead frame, a sub frame, hydraulic actuators linking the sub frame to the tamping arms, a number of tamping tools (often referred to as tynes), attached to the tamping arms and terminating in paddles. The tamping tools are adapted to move towards one another in a pincer-like motion in order to compress the ballast adjacent to and underlying the ties. Vibration of the tamping tools further compresses the ballast. In practice, multiple vibration devices may be employed in order to provide tools for tamping inside and outside the rails as well as forward and aft of the ties. Such tamping operations may be carried out at each tie via a tamper vehicle, which advances along the rails.

The amplitude and frequency of vibration imparted by the tamping tools in tamping ballast under ties of a railroad track should be controlled. If, for instance, the condition of the ballast under successive ties changes, vibrating the tamping tools with the same amplitude and the same frequency will result in inappropriate track tamping operations. However, adjusting the vibration of the tamping tools by traditional hydraulic valves, such as hydraulic proportional valves, is inefficient as such valves introduce losses due to flow throttling.

### BRIEF SUMMARY

The present disclosure relates to an energy efficient hydraulic drive associated with tamping units where the vibration of the tamping tools is adjustable in terms of both amplitude and frequency. In this regard, a hydraulic drive may be installed on the tamping unit to provide a drive for each of the tamping tools.

Such tamping units may be equipped with a mobile frame (e.g., a subframe) extendable in the vertical and transverse directions, tamping arms pivoting about the sub frame, linear hydraulic actuators that drive each tamping arm and tamping tools for compressing ballast. The position of the tamping tools may be sensed by displacement sensors associated with the linear hydraulic actuators. The vibration of the tamping tools as well as the motion of the tamping tools may be controlled based on the displacement sensor signal. Accordingly, the motion of each linear hydraulic actuator may be controlled by an associated variable-displacement servo-pump.

Each linear hydraulic actuator may include one or multiple internal chambers (e.g., cavities) into and/or out of which hydraulic fluid flows, as controlled by the variable-displacement servo-pump. In instances where each linear hydraulic actuator includes two chambers, the flow rate going into a first chamber of a linear hydraulic actuator and the flow rate coming out a second chamber of each linear hydraulic actuator may both flow through the associated variable-displacement servo-pump. In this manner, the vibration of each tamping tool may be adjusted in terms of both amplitude and frequency by varying the displacement of the variable-displacement servo-pump, thus enabling an energy-efficient functioning of the system. Accordingly, hydraulic valves may no longer be needed to be positioned between linear hydraulic actuators and variable-displacement servo-pumps, thereby removing the losses due to flow throttling.

In some embodiments, an apparatus may be provided. The apparatus may comprise: a rigid frame; a variable-displacement servo-pump operatively coupled to the frame; a double rod linear hydraulic actuator operatively coupled to the sub frame at a proximal end of the double rod linear hydraulic actuator and comprising: at least one internal cavity for receiving hydraulic fluid from the variable-displacement servo-pump via a hydraulic hose; and an actuator rod passing through a first internal cavity and a second internal cavity of the double rod linear hydraulic actuator; a tamping arm operatively coupled to a distal end of the double rod linear hydraulic actuator and a tamping tool coupled to the tamping arm.

In some embodiments, the double rod linear hydraulic actuator is configured to translate in a longitudinal direction along the actuator rod in response to the at least one internal cavity of the double rod linear hydraulic actuator receiving hydraulic fluid, thereby causing movement of at least one of the tamping tools.

In some embodiments, the apparatus may further comprise: a vibrator operatively coupled to the frame, wherein vibrations of the vibrator cause the tamping tool to vibrate when performing ballast tamping operations.

In some embodiments, the double rod linear hydraulic actuator comprises at least one of a displacement sensor, a pressure transducer, and a position sensor for collecting sensor data associated with the double rod linear hydraulic actuator.

In some embodiments, the apparatus may further comprise: an intelligent microcontroller for controlling displacement of hydraulic fluid between the variable-displacement servo-pump and the at least one cavity of the double rod linear hydraulic actuator in response to receiving sensor data associated with the double rod linear hydraulic actuator from at least one of the displacement sensor, the pressure transducer, and the position sensor.

In some embodiments, the apparatus may further comprise: another linear actuator defining a lower end operatively coupled to the sub frame and an upper end operatively coupled to a workhead frame operatively coupled to the vehicle frame for raising and lowering the apparatus in relation to the tamper vehicle frame. This linear actuator may be a single rod linear actuator.

In some embodiments, an apparatus may be provided. The apparatus may comprise: a rigid frame; a variable-displacement servo-pump operatively coupled to the frame; a linear hydraulic actuator system operatively coupled to the frame at a proximal end of the linear hydraulic actuator system and comprising: a first single rod linear hydraulic actuator and a second single rod linear hydraulic actuator operatively coupled to each other via one or more pins and oriented in opposite directions on a common plane, wherein each of the first single rod linear hydraulic actuator and the second single rod linear hydraulic actuator comprise: at least one internal cavity for receiving hydraulic fluid from the variable-displacement servo-pump via a hydraulic hose; and an actuator rod passing through only one cavity of the at least one internal cavity; and a tamping arm operatively coupled to a distal end of the linear hydraulic actuator system and a tamping tool coupled to the tamping arm.

In some embodiments, in response to at least one internal cavity of the first single rod linear hydraulic actuator and the second single rod linear hydraulic actuator receiving hydraulic fluid, the first single rod linear hydraulic actuator is configured to extend along the actuator rod of the first single linear hydraulic actuator in a first longitudinal direction and the second single rod linear hydraulic actuator is configured to extend along the actuator rod of the second single linear hydraulic actuator in a second longitudinal direction opposite the first longitudinal direction, thereby causing movement of the tamping arm and therefore the movement of the tamping arm.

In some embodiments, the apparatus may further comprise: a vibrator operatively coupled to the frame, wherein vibrations of the vibrator cause the tamping tool to vibrate when performing ballast tamping operations.

In some embodiments, at least one of the first linear hydraulic actuator and the second linear hydraulic actuator comprises at least one of a displacement sensor, a pressure transducer, and a position sensor for collecting sensor data associated with at least one of the first linear hydraulic actuator and the second linear hydraulic actuator.

In some embodiments, the apparatus may further comprise: an intelligent microcontroller for controlling displacement of hydraulic fluid between the variable-displacement servo-pump and the at least one cavity of the linear hydraulic actuator in response to receiving sensor data associated with the linear hydraulic actuator from at least one of the displacement sensor, the pressure transducer, and the position sensor.

In some embodiments, the apparatus may further comprise: another linear actuator defining a lower end operatively coupled to the sub frame and an upper end operatively coupled to a workhead frame operatively coupled to the vehicle frame for raising and lowering the apparatus in relation to the tamper vehicle frame. This linear actuator may be a single rod linear actuator.

In some embodiments, a method may be provided. The method may comprise: advancing a tamping vehicle along railroad tracks to a first predetermined location; lowering, relative to the tamping vehicle, a frame of a tamping apparatus by extending a first linear hydraulic actuator defining a lower end operatively coupled to the sub frame and an upper end operatively coupled to the workhead frame operatively coupled to the vehicle frame; tamping, using the tamping apparatus, ballast positioned underneath one or more rail ties of the railroad tracks; raising, relative to the tamping vehicle frame by retracting the first linear hydraulic actuator; and advancing the tamping vehicle along the railroad tracks to a second predetermined location.

In some embodiments, lowering the frame further comprises: lowering a tamping tool into the ballast for performing at least one tamping operation wherein an upper end of the tamping tool is operatively coupled to the tamping arm and the tamping arm is operatively coupled to a distal end of a second linear hydraulic actuator, and wherein a proximal end of the second linear hydraulic actuator is operatively coupled to the sub frame.

In some embodiments, tamping the ballast comprises: measuring, using at least one of a displacement sensor, a pressure transducer, and a position sensor associated with the second linear hydraulic actuator, at least one of a fluid property and a position of an actuator rod comprised in the second linear hydraulic actuator; receiving, at a microcontroller, sensor data associated with the second linear hydraulic actuator from at least one of the displacement sensor, the pressure transducer, and the position sensor; determining, using the microcontroller, an amount of hydraulic fluid to be displaced within at least one cavity of the second linear hydraulic actuator; and displacing, using a variable-displacement servo-pump, the determined amount of hydraulic fluid to at least one cavity of the second linear hydraulic actuator, thereby causing the second linear hydraulic actuator to extend or retract in a longitudinal direction along the actuator rod, wherein causing the second linear hydraulic actuator to extend or retract in a longitudinal direction along the actuator rod causes the tamping tool to move.

### BRIEF DESCRIPTION OF THE DRAWINGS

Reference is now made to the following descriptions taken in conjunction with the accompanying drawings.

FIG. 1 illustrates an exemplary rail tamper, in accordance with some embodiments of the disclosure;

FIG. 2 illustrates an exemplary tamping unit, in accordance with some embodiments of the disclosure;

FIG. 3 illustrates an exemplary schematic of a hydraulic system that utilizes a dual-chambered “double rod” linear hydraulic actuator, in accordance with some embodiments of the disclosure;

FIG. 4 illustrates an exemplary actuator system that utilizes two dual-chambered “single rod” linear hydraulic actuators, in accordance with some embodiments of the disclosure;

FIG. 5A illustrates an exemplary schematic of an actuator system that utilizes two dual-chambered “single rod” linear hydraulic actuators to perform an extension movement, in accordance with some embodiments of the disclosure; and

FIG. 5B illustrates an exemplary schematic of an actuator system that utilizes two dual-chambered “single rod” hydraulic actuators to perform a retraction movement, in accordance with some embodiments of the disclosure.

### DETAILED DESCRIPTION

Various embodiments of an apparatus and method for moving and vibrating tamping tools according to the present disclosure are described. It is to be understood, however, that the following explanation is merely exemplary in describing the devices and methods of the present disclosure. Accordingly, several modifications, changes and substitutions are contemplated.

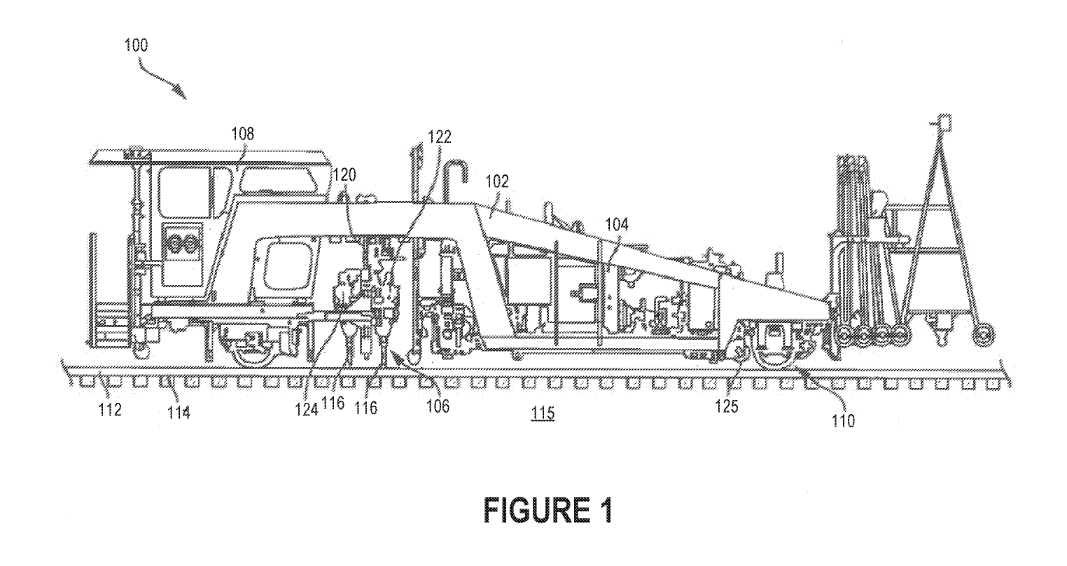

In some embodiments, the apparatus and method for moving and vibrating tamping tools may be employed in a tamping machine rail vehicle 100, as illustrated in FIG. 1. The tamping vehicle 100 may include a frame assembly 102, a propulsion device 104, a tamping unit 106 and a cabin 108. Frame assembly 102 may include a plurality of rigid frame members and a plurality of wheels 110 that are configured to travel on a pair of rails 112. During operation, the tamping vehicle 100 may travel across the pair of rails 112, which is disposed over a series of rail ties 114 operatively coupled and/or secured to the rails 112. The rails 112 and series of ties 114 may be disposed over a bed of ballast 115 (e.g., crushed stones, rocks, gravel, and/or the like).

The propulsion device 104 of the tamping vehicle 100 may be configured and/or utilized to move tamping vehicle 100 in one or more directions along the pair of rails 112. As the tamping vehicle 100 moves along the pair of rails 112, the tamping unit 106 may be configured to tamp ballast between rail ties 114 to reshape the ballast. This reshaping of the ballast may improve the alignment, stability, and/or durability of the rails 112 and/or rail ties 114.

The tamping unit 106 may include multiple workheads. In the side view of FIG. 1, one workhead can be viewed while another workhead may also be included at an opposite side corresponding with the other rail. Any number of workheads (e.g., 2, 4, etc.) may be included in the tamping unit 106.

As described in more detail below, the tamping unit 106 may include tamping arms 116, which are operatively coupled to tamping tools 126 that may be lowered into the ballast between rail ties 114. Movement of the tamping arms 116, and therefore the tamping tools 126, may be controlled by one or more actuators 118 operatively coupled to a sub frame 124 as further described below. For example, the tamping tools 126 may be actuated (e.g., be caused to move) by one or more hydraulic actuators 118 that squeeze the tamping tools 126 around the rail ties 114 when inserted into the ballast beneath the rail ties to thereby compact and/or otherwise reshape the ballast material.

The tamping unit 106 may further include a variable-displacement servo-pump 122 for monitoring and/or controlling of the flow of hydraulic fluid being sent to and/or received from each chamber of the hydraulic actuators 118 used to control movement of the tamping unit 106 and/or the tamping tools 126. The servo-pump 122 may be placed at a variety of positions on the rail vehicle 100. The amount and/or flow rate of hydraulic fluid being sent to each chamber of the hydraulic actuators 118 may cause the tamping arms 116 and therefore the tamping tools 126 to translate, pivot, and/or otherwise move in a variety of directions.

In some embodiments, the tamping unit 106 may be operatively coupled to the frame assembly 102 via a workhead frame 120, the sub frame 124 and an actuator operatively coupled between the workhead frame 120 and the sub frame 124. For example, the actuator (preferably a hydraulic actuator) may be operable to lower the tamping unit 106 such that the tamping tools 126 may be inserted into the ballast between adjacent rail ties 114 where squeezing and vibration actions may be performed to tamp (e.g., compress, reshape, etc.) the underlying ballast.

In an exemplary work cycle, the tamping vehicle 100 may advance along the rails 112 to position the tamping unit 106 over a first rail tie 114. A linear hydraulic actuator may then be actuated in response to hydraulic fluid being sent to and/or from each chamber of the actuator to thereby lower the tamping unit 106 (e.g., the tamping tools 126 into the ballast). Once lowered, the tamping tools 126 may be enabled to carry out the tamping operations of the ballast as desired, where movement of the tamping tools may be controlled by one or more actuators 118 in response to hydraulic fluid being sent to and/or from each chamber of the actuator. In some embodiments, the actuators 118 may cause vibration and thus causing the associated tamping tools 126 to vibrate during operation. Again, the flow of hydraulic fluid being sent to and/or from each chamber of the actuator(s) 118 used to control movement of the tamping unit 106 and/or the tamping tools 126 may be controlled by the variable-displacement servo-pump 122 and/or a hydraulic circuit included in the variable-displacement servo-pump. Once tamping operations are completed, the actuator that lowered the tamping unit may be actuated to raise (and in some cases stow) the tamping tools 126 and/or the tamping unit 106 as a whole for travel to a second rail tie 114.

The tamping vehicle 100 may also include a tracking device 125 that measures general linear movement of the rail vehicle 100 along the rail track 112. In this manner, the tracking device 125 may enable the tamping vehicle 100 to accurately position itself, the tamping unit 106, and/or the tamping tools 126 in relation to a rail tie 114. Additionally, cabin 108 of the tamping vehicle 100 may be structured such that it remains stationary relative to the frame assembly 102 as the rail vehicle 100 moves along the rails 112.

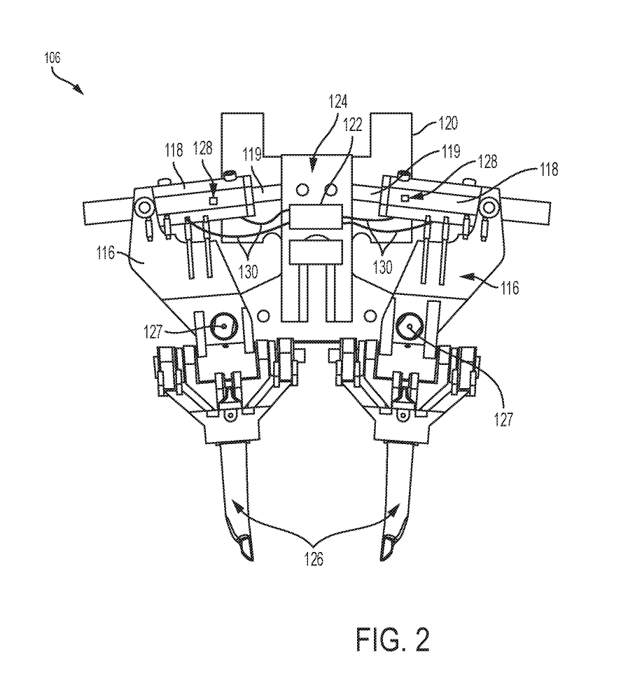

FIG. 2 illustrates the tamping unit 106 in more detail. As described above, the tamping unit 106 may include a sub frame 124, which may be extended in the vertical direction (e.g., raised and/or lowered) by an actuator during tamping operations. Additionally, the sub frame 124 of the tamping unit 106 may be operatively coupled to the frame assembly 102 (shown in FIG. 1 but not shown in FIG. 2) of the tamping vehicle 100 by one or more vertical bars (not pictured) extending downward from the workhead frame assembly 120. During operation, an actuator may cause the sub frame 124 of the tamping unit 106 to translate in a vertical direction (e.g., raise and/or lower) along the vertical bars. For example, the sub frame 124 may include one or more apertures (not pictured) through which the vertical bars may pass when the tamping unit 106 is raised and/or lowered (e.g., translated vertically) along the longitudinal direction of the vertical bars.

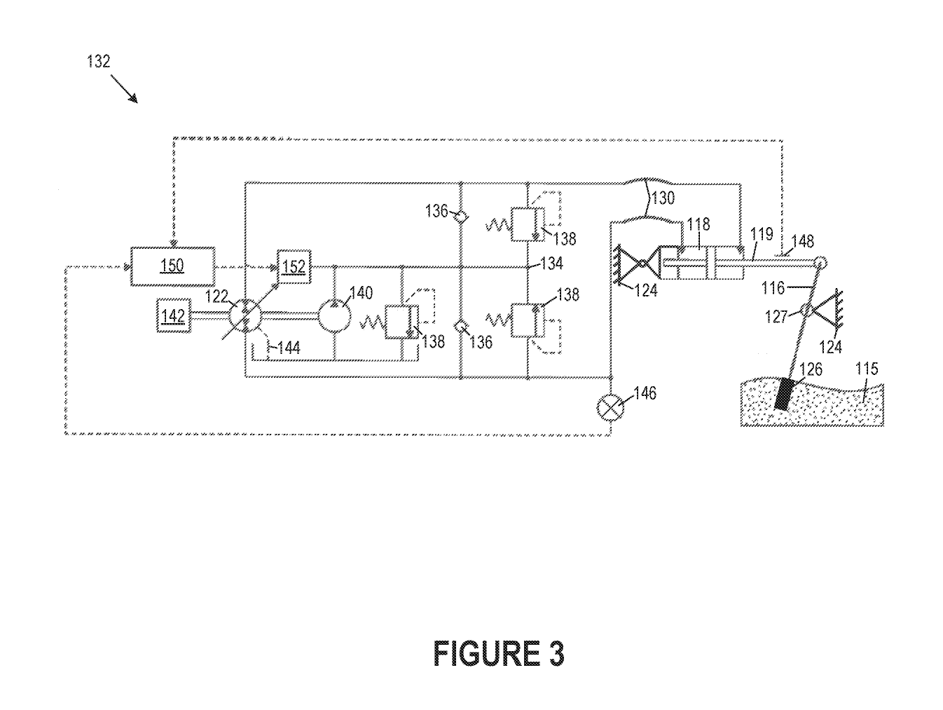

As described above, the tamping unit 106 may include tamping tools 126. Each tamping tool 126 may include a tamping pad at its lower end that is to be inserted into the ballast (e.g., lowered into the gravel bed beneath the rails 112 and/or the rail ties 114) during operation. In some embodiments, the tamping tools 126 may be mounted on the tamping arms 116 for pivoting about pivot joints 127 (shown in FIG. 2 and in FIG. 3) having pivot axes extending in a longitudinal direction of the rail ties 114 (e.g., orthogonal to the longitudinal direction of the rails 112) when being actuated by actuators 118.

The actuators 118 (e.g., linear hydraulic actuators) as described herein may be mechanically connected and/or otherwise operably coupled to each tamping arm 116 of the tamping unit 106 for moving the tamping tools 126 (e.g., pivoting the tamping arms about the pivot joints 127), in response to flow of hydraulic fluid in the chambers of the actuators coupled to the tamping arms. In some embodiments, the position of each tamping tool 126 may be sensed by a displacement sensor 128 associated with each actuator 118 and/or each chamber of each actuator. Each displacement sensor 128 may measure, monitor, and/or otherwise determine an amount of fluid (e.g., hydraulic fluid) held in each chamber of an actuator 118. Each displacement sensor 128 may also measure, monitor, and/or otherwise determine one or more fluid properties (e.g., pressure, volume, temperature, and/or the like) of a fluid being held inside of each chamber of an actuator 118.

In some embodiments, each displacement sensor 128 may include an electronic sensor, a transmitter, a transceiver, a wireless communication unit, a wired communication unit, and/or the like for capturing, transmitting, and/or receiving sensor data (e.g., measured values and/or properties of hydraulic fluid in each chamber of an actuator 118). Sensor data may be transmitted and/or received between displacement sensors 128 and a communication unit associated with the variable-displacement servo-pump 122 for controlling one or more flows of fluid (e.g., hydraulic fluid) to and/or from one or more chambers of actuators 118. Each of the displacement sensor 128 and the variable-displacement servo-pump 122 may include electrical circuits, computing processor hardware, and/or the like for making intelligent determinations of how fluid is to be dispersed among different elements of the apparatus described herein.

In some embodiments, the motion of each actuator 118 may determine the motion of the tamping tools 126. For example, when an actuator 118 extends outwardly in a direction along its longitudinal axis, the tamping arm and therefore the associated tamping tool 126 may pivot about a pivot joint 127. This pivoting action of the tamping arm 116 may cause the tamping tool 126 to move in a direction opposite of the direction in which the actuator 118 extends. Similarly, when the actuator 118 retracts inwardly in a direction along its longitudinal axis, the tamping arm 116 and therefore the associated tamping tool 126 may pivot about the pivot joint 127 to thus cause the tamping tool 126 to move in a direction opposite of the direction in which the actuator retracts.

In some embodiments, each actuator 118 may include one or more internal chambers (e.g., cavities) into which fluid (e.g., hydraulic fluid) is displaced. The displacement of fluid in each chamber of an actuator 118 may cause the actuator 118 to actuate (e.g., retract and/or extend in a linear direction and also vibrate). Additionally, the amount and/or flow of fluid displaced in each chamber of the actuator 118 may be determined and/or monitored by a displacement sensor 128 and/or controlled by the variable-displacement servo-pump 122. As shown in FIG. 2, each chamber of the actuators 118 may be connected to a hydraulic circuit of the variable-displacement servo-pump 122 by means of hydraulic hoses 130.

FIG. 3 shows a simplified schematic of a hydraulic system 132 used to power a dual-chambered “double rod” linear hydraulic actuator 118 in a closed-circuit configuration. The schematic may depict a hydraulic circuit included in and/or associated with the variable-displacement servo-pump 122 that is utilized to disperse hydraulic fluid among various elements of the hydraulic system 132.

As described above and with reference to FIG. 3, a dual-chambered double rod linear hydraulic actuator 118 may be operatively coupled to the sub frame 124. The actuator 118 may also be hydraulically coupled with an associated variable-displacement servo-pump 122 via hydraulic hoses 130. For example, each chamber of the actuator 118 may be connected to one port of the associated variable-displacement servo-pump 122 by means of two hydraulic hoses 130. Additionally, each chamber of the actuator 118 may be connected to a low-pressure source 134 through both check valves 136 and relief valves 138. In some embodiments, a dedicated charge pump 140 may feed the low-pressure source 134.

In some embodiments, the double rod actuator 118 of FIG. 3 may be actuated when more hydraulic fluid is displaced within a first chamber of the double rod actuator 118 than a second chamber of the double rod actuator 118. Displacing more hydraulic fluid within the first chamber of the double rod actuator 118 increases the pressure within the first chamber of the double rod actuator 118, which thus causes the double rod actuator 118 to translate (e.g., move, slide, and/or the like) along the actuator rod 119 disposed within both the interior of the first and second chambers of the double rod actuator 118 in a first direction.

Each actuator 118 included in the tamping unit 106 may be driven by a dedicated variable-displacement servo-pump 122 or multiple variable-displacement servo-pumps 122. Alternatively, multiple actuators 118 may be driven by a common variable-displacement servo-pump 122. Each variable-displacement servo-pump 122 may be powered by a combustion engine 142 of the tamping unit 106. Each variable-displacement servo-pump 122 may also include an external drain 144 connected to a hydraulic tank of the tamping unit 106 for discharging hydraulic fluid as desired.

In some embodiments, the check valves 136 may serve the purpose of reintroducing any external losses of hydraulic fluid that have been driven to the hydraulic tank of the tamping unit 106 via the external drain 144 back into the hydraulic system 132 for use. In this manner, hydraulic fluid may be recycled and/or reused as it is collected in the hydraulic tank of the tamping unit 106.

Further, the hydraulic system 132 may include an electronic control system that includes electronic sensors for measuring and/or monitoring hydraulic pressure in each chamber (e.g., a pressure transducer 146) and/or a position of an actuator rod 119 inside each chamber of an actuator 118 (e.g., a position sensor 148). In addition to and/or instead of a position sensor 148, an angular sensor (not pictured) may be coupled to a pivot joint 127 so as to measure an angle of a tamping tool 126. In some embodiments, each of the pressure transducer 146 and/or the position sensor 148 may also include the displacement sensor 128 as described above, and/or vice versa. Sensor signals and/or sensor data collected by the sensors 128, 146, 148 may be electrically transmitted to a digital microcontroller 150, where a desired hydraulic fluid displacement setting for each variable-displacement servo-pump 122 may be calculated. For example, the microcontroller 150 may execute a feedback control algorithm and send a command signal to an electrohydraulic valve included in a pump adjustment system 152, which may regulate fluid displacement of the variable-displacement servo-pump 122 to control the flow rate of hydraulic fluid flowing into and/or out of the variable-displacement servo-pump 122 in a suitable manner.

In some embodiments, a goal of the hydraulic system 132 may be to create a motion of the actuator 118 characterized by a vibration adjustable in terms of both amplitude and frequency. Since the tamping arm 116 and therefore the tamping tool 126 is mechanically coupled to the actuator 118, vibration of the actuator may result in vibration of the tamping tool 126. This vibration of the tamping tool 126 may be controlled by adjusting a swashplate angle of the variable-displacement servo-pump 122 based on a measured position of a linear actuator rod 119 inside each chamber of the actuator 118. In some embodiments, the position of the linear actuator rod 119 inside each chamber of the actuator 118 may be measured using the position sensor 148 and/or displacement sensor 128. Both frequency and amplitude of the vibration of the tamping tool 126 may be adjusted to any value between zero and the upper limit of the system using the microcontroller 150.

Moreover, monitoring the pressure in each chamber of the actuator 118 (e.g., each chamber being in which hydraulic fluid is displaced by the variable-displacement servo-pump 122) using the pressure sensor 146 may provide increased safety of operation by enabling the microcontroller 150 to limit a maximum squeezing force being applied to the ballast by the tamping tool 126 during operation (i.e., when tamping the ballast 115). For example, if a critical pressure (e.g., a pressure value that exceeds a predetermined threshold pressure value) is sensed by a pressure sensor 146, a specific control algorithm executed by the microcontroller 150 may cause the variable-displacement servo-pump 122 to destroke (e.g., stop operation, reduce and/or limit fluid flow rate, and/or the like) and thereby limit the maximum squeezing pressure being applied to the ballast 115 by the tamping tool 126.

Another advantage of the hydraulic system 132 as described herein is the ability to achieve a desired amount (e.g., amplitude and/or frequency) of vibration of the tamping tool 126 without introducing any throttle loss between the variable-displacement servo-pump 122 and the actuator 118. In fact, by utilizing a dual-chambered actuator 118 (as well as other embodiments described herein), the hydraulic system 132 may not require any hydraulic valve to be positioned between the actuator 118 and the variable-displacement servo-pump 122 of the hydraulic system 132. Instead, a direct hydraulic coupling (e.g., the hydraulic hose 130) may connect the variable-displacement servo-pump 122 directly to the actuator 118. This capability of more easily adjusting vibration of the tamping tool 126 without utilizing hydraulic valves between the actuator 118 and the variable-displacement servo-pump 122 may provide a significant improvement to the field of art in terms of overall efficiency and fuel savings of the hydraulic system 132. Prior to the present disclosure, hydraulic valves have been necessarily positioned between actuators and the displacement pumps in hydraulic systems to adjust vibrations of tamping pads, thereby introducing unwanted metering losses between the displacement pumps and the actuators.

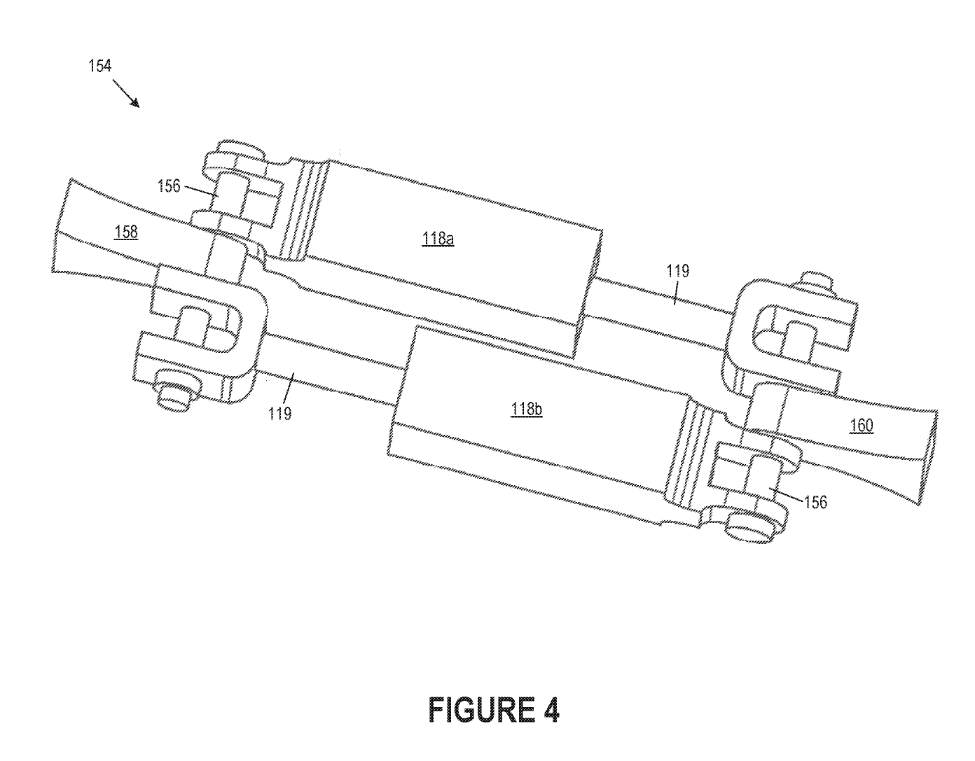

An alternative to utilizing a double rod actuator 118 as described with reference to FIG. 3 that achieves the same end result of increased efficiency and fuel savings may include utilizing actuator system 154 as shown in FIG. 4 instead of a double rod actuator 118. Now referring to FIG. 4, the actuator system 154 may include two dual-chamber “single rod” actuators 118 (e.g., a first single rod actuator 118a and a second single rod actuator 118b) coupled together via pins 156 as shown in FIG. 4. The actuator system 154 may couple to the sub frame 124 of the tamping unit 106 via a first mounting port 158. The actuator system 154 may couple to a tamping arm 116 via a second mounting port 160. Each of the single rod actuators 118a, 118b may be driven by a variable-displacement servo-pump 122, which may be coupled to each single rod actuator 118a, 118b via a hydraulic hose 130.

Similar to operation of the dual-chamber actuator 118 described with reference to FIG. 3, the actuator system 154 of FIG. 4 may be utilized to control movement of the associated tamping tool 126 (via the tamping arm 116) in response to hydraulic fluid flowing into and/or out of a chamber of each single rod actuator 118a, 118b of the actuator system 154. However, because the actuator system 154 may utilize two single rod actuators 118a, 118b to actuate and move the associated tamping arm 116 instead of one double rod actuator 118, a first single rod actuator 118a of the actuator system 154 may be responsible for causing the associated tamping tool 126 to move in a first direction, while a both single rod actuators 118a and 118b of the actuator system 154 may be responsible for causing the associated tamping tool 126 to move in a second direction that is opposite the first direction.

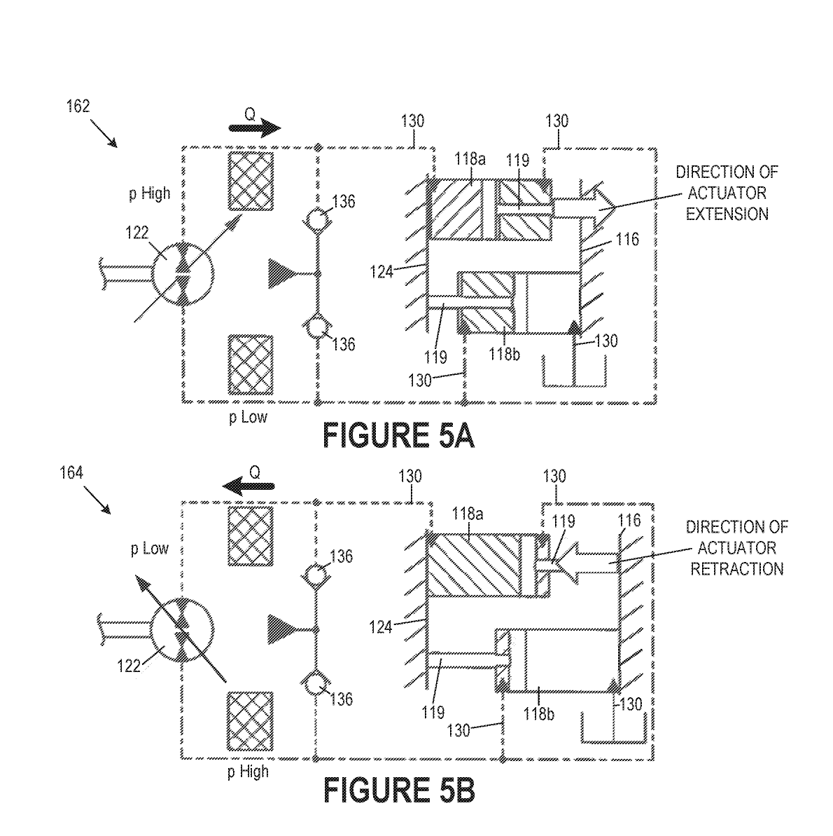

For example, with reference to the hydraulic schematic 162 of FIG. 5A, a first single rod actuator 118a may be actuated when more hydraulic fluid is displaced within a first chamber of the first single rod actuator 118a than a second chamber of the first single rod actuator 118a. Displacing more hydraulic fluid within the first chamber of the first single rod actuator 118a increases the pressure within the first chamber of the first single rod actuator 118a, which thereby causes the first single rod actuator 118a to extend (e.g., translate, move, slide, and/or the like) along the actuator rod 119 disposed within the interior of the second chamber of the first single rod actuator 118a in a first direction.

Unlike operation of the double rod actuator 118, the actuator system 154 of FIG. 4 that utilizes two single rod actuators 118 may require the variable-displacement servo-pump 122 to coordinate hydraulic fluid flow between both single rod actuators 118 of the actuator system 154. Areas of high and low pressure (p High and p Low) and direction of flow rate (Q) are illustrated in FIG. 5A and FIG. 5B. Accordingly, fluid may be displaced in and/or withdrawn from a first chamber of the second single rod actuator 118b to utilize, offset, and/or overcome the exerted force in the second direction.

While various embodiments of an apparatus and method for moving and vibrating tamping tools have been described above, it should be understood that they have been presented by way of example only, and not limitation. Thus, the breadth and scope of the present disclosure should not be limited by any of the above-described exemplary embodiments, but should be defined only in accordance with the following claims and their equivalents. Moreover, the above advantages and features are provided in described embodiments, but shall not limit the application of the claims to processes and structures accomplishing any or all of the above advantages.

Additionally, the section headings herein are provided for consistency with the suggestions under 37 CFR 1.77 or otherwise to provide organizational cues. These headings shall not limit or characterize the invention(s) set out in any claims that may issue from this disclosure. Specifically and by way of example, a description of a technology in the “Background” is not to be construed as an admission that technology is prior art to any invention(s) in this disclosure. Neither is the “Brief Summary” to be considered as a characterization of the invention(s) set forth in the claims found herein. Furthermore, any reference in this disclosure to “invention” in the singular should not be used to argue that there is only a single point of novelty claimed in this disclosure. Multiple inventions may be set forth according to the limitations of the multiple claims associated with this disclosure, and the claims accordingly define the invention(s), and their equivalents, that are protected thereby. In all instances, the scope of the claims shall be considered on their own merits in light of the specification, but should not be constrained by the headings set forth herein.

What is claimed is:

1. A rail vehicle comprising:
a sub frame;
a variable-displacement servo-pump operatively coupled to the vehicle;
a double rod linear hydraulic actuator operatively coupled to the sub frame at a proximal end of the double rod linear hydraulic actuator and comprising:
at least one internal cavity for receiving hydraulic fluid from the variable-displacement servo-pump via a hydraulic hose; and
an actuator rod passing through a first internal cavity and a second internal cavity of the double rod linear hydraulic actuator; and
a tamping tool operatively coupled to a distal end of the double rod linear hydraulic actuator via a tamping arm, wherein the servo-pump drives the double rod linear hydraulic actuator to impart a squeezing motion and vibration motion to the tamping tool.

2. The rail vehicle of claim 1, further comprising:
a tamping pad forming a lower end of the tamping tool, wherein the tamping pad is configured to be lowered into ballast underlying railroad tracks and between rail ties of the railroad tracks for performing ballast tamping operations.

3. The rail vehicle of claim 1, wherein the double rod linear hydraulic actuator is configured to translate in a longitudinal direction along the actuator rod in response to the at least one internal cavity of the double rod linear hydraulic actuator receiving hydraulic fluid, thereby causing movement of at least one of the tamping tool.

4. The rail vehicle of claim 1, wherein the double rod linear hydraulic actuator comprises at least one of a displacement sensor, a pressure transducer, and a position sensor for collecting sensor data associated with the double rod linear hydraulic actuator.

5. The rail vehicle of claim 4, further comprising:
an intelligent microcontroller for controlling displacement of hydraulic fluid between the variable-displacement servo-pump and the at least one cavity of the double rod linear hydraulic actuator in response to receiving sensor data associated with the double rod linear hydraulic actuator from at least one of the displacement sensor, the pressure transducer, and the position sensor.

6. The rail vehicle of claim 1, further comprising:
a linear actuator defining a lower end operatively coupled to the frame and an upper end operatively coupled to a workhead frame for raising and lowering the apparatus in relation to the tamper vehicle frame.

7. A rail vehicle comprising:
a sub frame;
a variable-displacement servo-pump operatively coupled to the vehicle;
a linear hydraulic actuator system operatively coupled to the sub frame at a proximal end of the linear hydraulic actuator system and comprising:
a first single rod linear hydraulic actuator and a second single rod linear hydraulic actuator operatively coupled to each other via one or more connectors and oriented in opposite directions on a common plane, wherein each of the first single rod linear hydraulic actuator and the second single rod linear hydraulic actuator comprise:
at least one internal cavity for receiving hydraulic fluid from the variable-displacement servo-pump via a hydraulic hose; and
an actuator rod passing through only one cavity of the at least one internal cavity; and
a tamping tool operatively coupled to a distal end of the linear hydraulic actuator system via a tamping arm.

8. The rail vehicle of claim 7, further comprising:
a tamping pad forming a lower end of the tamping tool, wherein the tamping pad is configured to be lowered into ballast underlying railroad tracks and between rail ties of the railroad tracks for performing ballast tamping operations.

9. The apparatus of claim 7, wherein, in response to at least one internal cavity of the first single rod linear hydraulic actuator and the second single rod linear hydraulic actuator receiving hydraulic fluid, the first single rod linear hydraulic actuator is configured to extend along the actuator rod of the first single linear hydraulic actuator in a first longitudinal direction and the second single rod linear hydraulic actuator is configured to extend along the actuator rod of the second single linear hydraulic actuator in a second longitudinal direction opposite the first longitudinal direction, thereby causing movement of the tamping tool.

10. The apparatus of claim 7, wherein at least one of the first linear hydraulic actuator and the second linear hydraulic actuator comprises at least one of a displacement sensor, a pressure transducer, and a position sensor for collecting sensor data associated with at least one of the first linear hydraulic actuator and the second linear hydraulic actuator.

11. The apparatus of claim 10, further comprising:
an intelligent microcontroller for controlling displacement of hydraulic fluid between the variable-displacement servo-pump and the at least one cavity of the linear hydraulic actuator in response to receiving sensor data associated with the linear hydraulic actuator from at least one of the displacement sensor, the pressure transducer, and the position sensor.

12. The apparatus of claim 7, further comprising:
another linear actuator defining a lower end operatively coupled to a frame and an upper end operatively coupled to a workhead frame for raising and lowering the apparatus in relation to the tamper vehicle frame.

13. A method comprising:
advancing a tamping vehicle along railroad tracks to a first location;
lowering, relative to the tamping vehicle, a frame of a tamping apparatus by extending a first linear hydraulic actuator defining a lower end operatively coupled to the frame and an upper end operatively coupled to the tamping vehicle;
tamping, using the tamping apparatus, ballast positioned underneath one or more rail ties of the railroad tracks;
raising, relative to the tamping vehicle, the frame by retracting the first linear hydraulic actuator; and
advancing the tamping vehicle along the railroad tracks to a second location.

14. The method of claim 13, wherein lowering the frame further comprises:
lowering a tamping tool into the ballast for performing at least one tamping operation, wherein the tamping tool is operatively coupled to a tamping arm, wherein an upper end of the tamping arm is operatively coupled to a distal end of a second linear hydraulic actuator, and wherein a proximal end of the second linear hydraulic actuator is operatively coupled to a sub frame.

15. The method of claim 14, wherein tamping the ballast comprises:
measuring, using at least one of a displacement sensor, a pressure transducer, and a position sensor associated with the second linear hydraulic actuator, at least one of a fluid property and a position of an actuator rod comprised in the second linear hydraulic actuator;
receiving, at a microcontroller, sensor data associated with the second linear hydraulic actuator from at least one of the displacement sensor, the pressure transducer, and the position sensor;
determining, using the microcontroller, an amount of hydraulic fluid to be displaced within at least one cavity of the second linear hydraulic actuator; and
displacing, using a variable-displacement servo-pump, the determined amount of hydraulic fluid to at least one cavity of the second linear hydraulic actuator, thereby causing the second linear hydraulic actuator to extend or retract in a longitudinal direction along the actuator rod, wherein causing the second linear hydraulic actuator to extend or retract in a longitudinal direction along the actuator rod causes the tamping tool to move.

16. The method of claim 14, wherein tamping the ballast comprises:
vibrating the second linear hydraulic actuator, thereby causing the tamping tool to vibrate.

17. The method of claim 13, wherein the second linear hydraulic actuator comprises a double rod linear hydraulic actuator.

18. The method of claim 13, wherein the second linear hydraulic actuator comprises a single rod linear hydraulic actuator system comprising:
a first single rod linear hydraulic actuator and a second single rod linear hydraulic actuator operatively coupled to each other via one or more pins and oriented in opposite directions on a common plane.

19. The method of claim 13, further comprising:
identifying at least one of the first location and the second location using a tracking device associated with the tamping vehicle.
